(19) United States
(12) Patent Application Publication
(10) Pub. No.: US 2017/0320240 A1
(43) Pub. Date: Nov. 9, 2017

(54) EMBOSSING DIES HAVING POLYMER LAYERS

(71) Applicant: HEWLETT-PACKARD INDIGO B.V., Amstelveen (NL)

(72) Inventor: Ilan MEIRI, Yavne (IL)

(21) Appl. No.: 15/520,291

(22) PCT Filed: Oct. 31, 2014
(86) PCT No.: PCT/EP2014/073496

§ 371 Date: Apr. 19, 2017

(51) Int. Cl. B29C 33/38; B29C 33/40; B44C 3/02; B44B 5/02; B44C 3/00; B29C 67/00

(52) U.S. Cl. CPC B29C 33/3842; B44C 3/025; B44B 5/026; B29C 33/40; B29C 67/00; B44C 3/00

(57) ABSTRACT

Provided is a method of manufacturing an embossing die. The method comprises mounting a drum or a plate on a support, providing information on a shape of the embossing die, printing a multitude of photopolymer drops forming a photopolymer layer upon the drum or the plate based on the provided information, and curing the printed photopolymer layer.

Usually, an embossing process is based on the use of an embossing die carrying an embossing shape, wherein the substrate is pressed against the embossing die with a specific level of pressure in order to produce permanently raised or recessed areas in the substrate corresponding to the embossing shape.

The term “embossing” as used throughout the specification and claims relates to a process of creating raised and recessed areas in a substrate in accordance with a specific design.

### BRIEF DESCRIPTION OF DRAWINGS

Certain examples are described in the following detailed description and in reference to the drawings, in which:

FIGS. 1a and 1b show schematic views of embossing apparatus;

FIGS. 2a and 2b show schematic views of further apparatus;

FIG. 3 shows a schematic view of an embossing drum manufacturing apparatus;

FIG. 4 shows a schematic view of an embossing plate manufacturing apparatus; and

FIG. 5 shows a flow chart of an embossing die manufacturing process.

### DETAILED DESCRIPTION

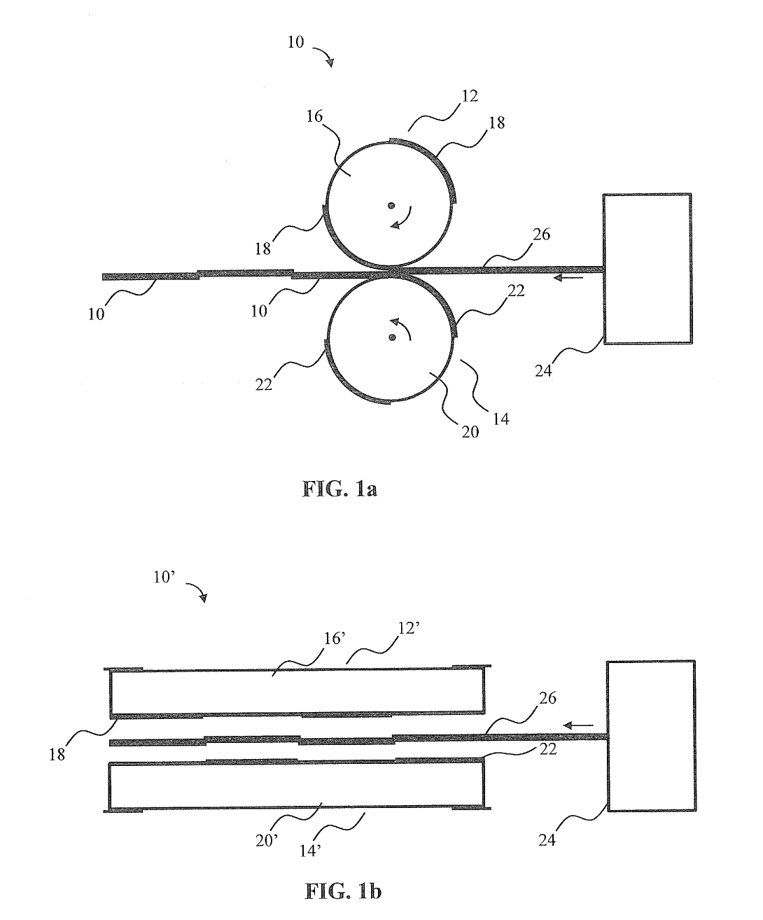

FIGS. 1a and 1b show schematic views of two embossing apparatus 10, 10′|_{[MK1]}. Each embossing apparatus 10, 10′ has a first die 12, 12′ and a second die 14, 14′. In this context, the term “die” as used throughout the description and claims refers to any structure that can be used for embossing or debossing a part or parts of a substrate, i.e., any object that has a three-dimensional surface that produces permanently raised or recessed areas in a substrate when the substrate is pressed against the die with a specific level of pressure.

As can be seen from FIGS. 1a and 1b, each of the first dies 12, 12′ has a first body 16, 16′ on which an embossing shape is formed by a first polymer layer 18 adhering to a surface of the first body 16, 16′. In the specific example of FIGS. 1a and 1b, the embossing shape formed by the first polymer layer 18 comprises two embossed portions of equal size.

Likewise, each of the second dies 14, 14′ has a second body 20, 20′on which a background is formed by a second polymer layer 22 adhering to a surface of the second body 20, 20′. The background formed by the second polymer layer 22 corresponds to the embossing shape formed by the first polymer layer 18, i.e., the embossed portions of the first polymer layer 18, forming the embossing shape, fit into debossed portions of the second polymer layer 22, forming the background.

In an example, when the embossed portions of the first polymer layer 18 dive into debossed portions of the second polymer layer 22, a gap remains between a peripheral edge of an embossed portion and an edge of a debossed portion surrounding the embossed portion, thus giving room to the substrate sandwiched between the embossed portion and the debossed portion. Thus, the expression “fit into” is intended to encompass scenarios where an embossed portion does not completely fill out a corresponding debossed portion.

The first and the second polymer layers 18, 22 may be continuous layers having embossed or debossed portions. However, the first and the second polymer layers 18, 22 may also be formed of separate portions that are distributed over the surface of the first or the second body 16, 16′, 20, 20′, wherein an embossed portion is formed by the presence of the first or the second polymer layer 18, 22 while a debossed portion is formed by the absence of the first or the second polymer layer 18, 22 on the surface of the first or the second body 16, 16′, 20, 20′. In this regard, the term “debossed portion” is intended to encompass the absence of a polymer layer, i.e., an open area in the first or the second polymer layer 18, 22.

Moreover, the embossed or debossed portions of the first or the second polymer layer 18, 22 may have a same height or depth but may also have different heights and depths. For example, a first debossed portion may be formed by an open area in the first or the second polymer layer 18, 22 while a second debossed portion with a smaller depth may be formed by a thin portion of the first or the second polymer layer 18, 22.

Furthermore, although FIGS. 1a and 1b show first and second bodies 16, 20 in the form of drums for rotary embossing and plates for flatbed embossing, it is clear that the bodies 16, 16′, 20, 20′ may take on any faun., with the shown rotary dies 12, 14 and flatbed dies 12′, 14′ being specific examples.

Each apparatus 10, 10′ has a feeder 24 to guide a substrate 26, e.g., sheets or a web of paper or other material to be embossed, between the first die 12, 12′ and the second die 14, 14′. In this regard, the feeder 24 may comprise a sheet guide or a web guide, i.e., elements that guide sheets or a web along a predefined path from a substrate stock past the first die 12, 12′ and the second die 14, 14′ to an output terminal.

When the feeder 24 guides the substrate 26 between the first die 12, 12′ and the second die 14, 14′, the two raised portions of the embossing shape formed by the first polymer layer 18 press the substrate 26 into the corresponding recessed portions of the background 22, thereby producing sharp bends in the substrate 26 that result in permanently raised and recessed areas of the substrate 26.

The height and depth, respectively, of the surface of the raised and the recessed areas of the substrate 26 depend on the height of the raised (embossed) portions of the embossing shape and the depth of the corresponding recessed (debossed) portions of the background. For example, the height of the raised portions of the embossing shape formed by the first polymer layer 18 may be more than 25 microns or more than 50 microns. I.e., the height difference between the embossing shape formed by raised portions of the first polymer layer 18 and a surface of the first polymer layer 18 that does not form part of the design to which the embossing shape corresponds may be more than 25 microns or more than 50 microns. Analogously, the depth of the recessed portions of the background formed by the second polymer layer 22 may be more than 25 microns or more than 50 microns. I.e., the height difference between the recessed portions of the second polymer layer 22 and a surface of the second polymer layer 22 that does not form part of the design to be embossed may be more than 25 microns or more than 50 microns.

In an example, the first polymer layer 18 and the second polymer layer 22 are photopolymer layers that are printed onto the first and the second body 16, 16′, 20, 20′ while the first and the second body 16, 16′, 20, 20′ are mounted in the embossing apparatus 10, 10′.

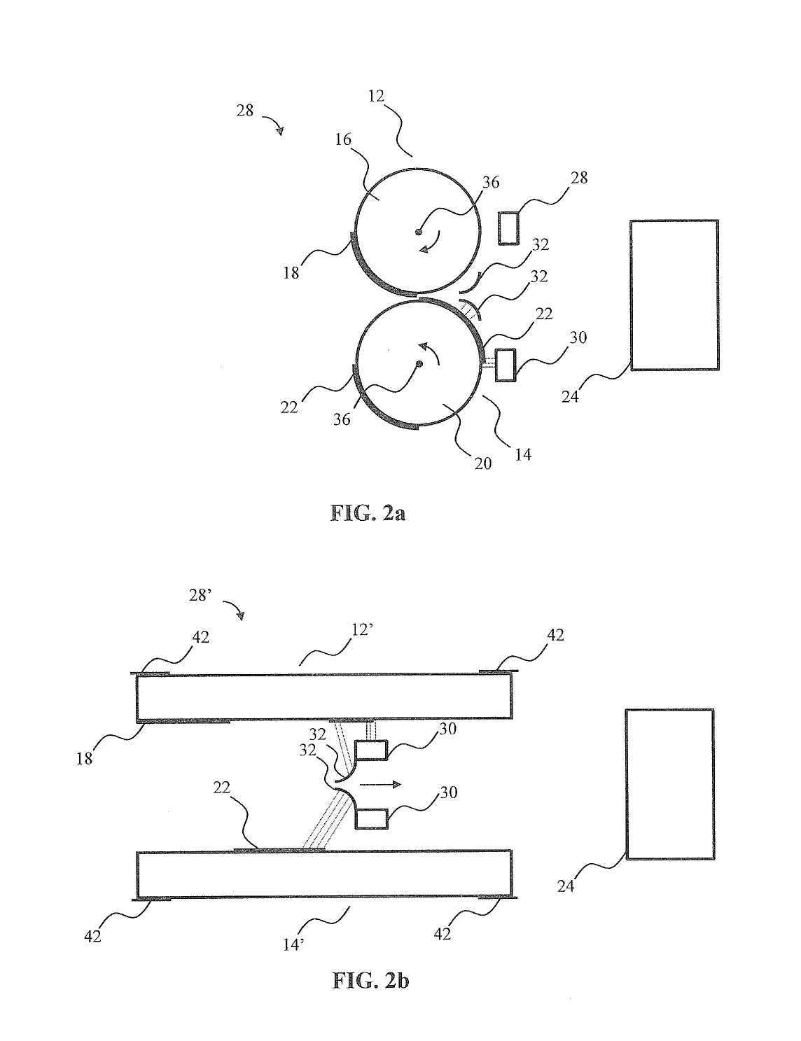

For example, apparatus 28, 28′ as shown in FIGS. 2a and 2b which correspond to apparatus 10, 10′ shown in FIGS. 1a and 1b comprise ink jet print heads 30 to print the first and second polymer layers 18, 22 directly onto the surface of the first and the second body 16, 16′, 20, 20′, respectively. Alternatively, the surface of the first and the second body 16, 16′, 20, 20′ may be provided with a polymer, plastics or paper layer or any other material suitable for printing photopolymer drops thereon in advance, i.e., before printing the first and the second photopolymer layer 18, 22.

Although, FIGS. 2a and 2b show two ink jet print heads 30, |_{[HN2]}one ink jet print head 30 or a multitude of ink jet print heads 30, for example stacked in a row, may be present in apparatus 28, 28′, to save costs and to speed up the printing process, respectively. For example, a single ink jet print head 30 may be mounted on a bearing that allows rotating the ink jet print head 30 into different directions or moving the ink jet print head 30 to different locations so that the ink jet print head 30 is enabled to consecutively print the first and the second polymer layer 18, 22 directly onto the surface of the first and the second body 16, 16′, 20, 20′.

If the polymer layers 18, 22 are photopolymer layers, as in the example of FIGS. 2a and 2b, the apparatus 28, 28′ may comprise ultra violet, UV, light sources 32, such as mercury-vapor lamps or light emitting diodes, LEDs, which emit UV light upon the first die 12, 12′ and the second die 14, 14′ to cure the printed photopolymer on the surface of the first and the second body 16, 16′, 20, 20′. The UV light may, for example, be light having a wavelength of between 380 nm and 100 nm. In accordance therewith, the first and the second polymer layer 18, 22 may be UV ink layers, for example free radical based or a cationic based UV ink layers.

As shown in FIG. 2a, the first and the second body 16, 20 may rotate as indicated by the arrows and the ink jet print heads 30 may supply photopolymer drops (droplets) to the surface of the first and the second body 16, 20. Depending on the desired height of the embossing shape and the desired depth of the background, at least one of the rotational speed of the bodies 16, 20 and the overall number of revolutions of the bodies 16, 20 during printing may be controlled to be within a suitable range to allow the ink jet print heads 30 to deposit a required number of photopolymer drops, as defined by the embossing shape and the background, in each portion of the surface of the first and the second body 16, 20. After being deposited on the surface of the first and the second body 16, 20, the surface of the rotating bodies 16, 20 may expose the photopolymer drops to a light beam emitted from the UV light sources 32 for curing. After curing, further photopolymer drops may be printed upon the cured photopolymer drops to build on the desired embossing shape and background.

In another example, as shown in FIG. 2b, the first and the second body 16′, 20′ may remain in a specific position and the ink jet print heads 30 may move along specified paths parallel to the surfaces of the first and the second body 16′, 20′ and supply photopolymer drops to the surface of the first and the second body 16′, 20′. Depending on the desired height of the embossing shape and the desired depth of the background, at least one of the speed of the linear movement of the ink jet print heads 30 and the overall number of passes of the ink jet print heads 30 past the surface of the first and the second body 16′, 20′ may be controlled to allow the ink jet print heads 30 to deposit the required number of photopolymer drops, as defined by the embossing shape and the background, in each portion of the surface of the first and the second body 16′, 20′.

After being deposited on the surface of the first and the second body 16′, 20′, the UV light sources 32, following or being coupled to the ink jet print heads 30, may emit a light beam onto the printed photopolymer drops and cure them. After being cured, the photopolymer drops form polymer layers 18, 22 having a specific rigidity suitable for embossing a specific substrate. In order to control rigidity of the cured photopolymer, the photopolymer may comprise epoxy additives.

As renewing the polymer layers 18, 22 in the process described above is simple and fast, embossing may be efficiently applied to very short runs. In this regard, it is to be noted that requirements imposed on the embossing polymer layers 18, 22 in view of resistance can be eased when dealing with short or ultra-short runs, i.e. up to 1000 or up to 500 embossing actions, when compared with requirements imposed on embossing polymer layers 18, 22 for long or ultra-long runs. For example, the polymer layers 18, 22 may have a resistance that usually lets them endure up to 500 or up to 1000 embossing actions without considerable wear but the resistance of the polymer layers 18, 22 may not be required to allow for 5000 or more embossing actions.

In this regard, the apparatus 28, 28′ may comprise a control device that controls the shape of the photopolymer layers 18, 22. In case that the control device detects deviations between the shape of the photopolymer layers 18, 22 and an intended or original shape, for example due to strain caused by the embossing process, the control device may cause the ink jet print heads 30 to repair the photopolymer layers 18, 22. For example, the control device may cause the ink jet print heads 30 to repair the photopolymer layers 18, 22 by printing further photopolymer drops onto the photopolymer layers 18, 22. Alternatively, the control device may cause a doctoring device to doctor the worn photopolymer layers 18, 22 and may further cause the ink jet print heads 30 to restore the desired embossing shape and background by re-printing the photopolymer layers 18, 22.

Heretofore, the control device may comprise a camera. For example, the camera may receive light reflected by the photopolymer layers 18, 22 or the embossed substrate, wherein the reflected light has been emitted by a device that emits structured light. Alternatively, the photopolymer layers 18, 22 may be provided with a coating of a specific color. In this case, accuracy of the shape of the photopolymer layers 18, 22 may be controlled by checking the color and in particular color distribution or evenness of the photopolymer layers 18, 22. For example, the photopolymer layers 18, 22 may be transparent and coated with a photopolymer coating having a specific color. The color may be chosen to correspond to the color of a substrate which is converted in the embossing process, for example a red photopolymer coating for a red substrate. Once parts of the photopolymer layers 18, 22 get worn, the color of the photopolymer layers 18, 22 may shift from the specific color, e.g., red, to light, e.g., light red, to transparent thereby indicating wear. The control device may then cause the ink jet print heads 30 to repair the photopolymer layers 18, 22 by printing further photopolymer drops having the specific color to the transparent and light areas until the original color distribution or color evenness over the whole the photopolymer layers 18, 22 is achieve or by doctoring the worn photopolymer layers 18, 22 and restoring the desired embossing shape and background.

Instead of being manufactured in the apparatus 28, the rotary embossing dies 12, 14 may be manufactured in advance and mounted to the embossing apparatus 10 thereafter. In this regard, FIG. 3 shows a schematic view of an embossing drum manufacturing apparatus 34 on which rotary embossing dies 12, 14 may be manufactured. The embossing drum manufacturing apparatus 34 comprises a rotatable support 36 to mount a drum 38 thereon (indicated by the dotted circle) and an ink-jet print head 30 to print a curable polymer layer directly upon the drum 38. The manufacturing process the rotary embossing die 12, 14 may be analogously to the manufacturing process described with regard to FIG. 2a. In particular, the embossing drum manufacturing apparatus 34 may comprise an UV light source 32 and the curable polymer layer may be a photopolymer layer or an UV ink layer to be printed directly upon the drum 38.

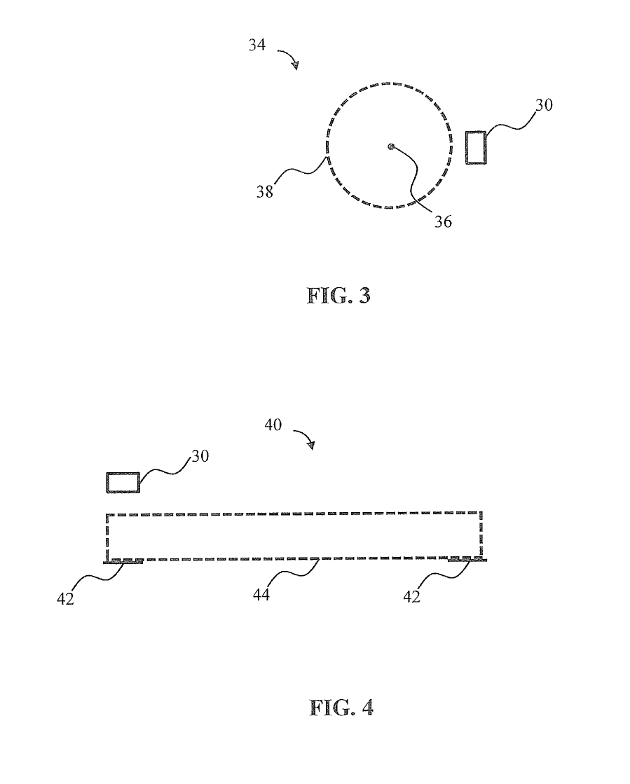

Likewise, the flatbed embossing dies 12′, 14′ may be manufactured outside apparatus 28′. For example, FIG. 4 shows a schematic view of an embossing plate manufacturing apparatus 40. The embossing plate manufacturing apparatus 40 comprises a support 42 to mount a plate 44 thereon (indicated by the dotted rectangle) and an ink-jet print head 30 to print a curable polymer layer upon the plate 44. The manufacturing process may be analogously to the manufacturing process described with regard to FIG. 2b. In particular, the embossing plate manufacturing apparatus 40 may comprise an UV light source 32 and the curable polymer layer may be photopolymer layer or a UV ink layer to be printed directly upon the plate 44.

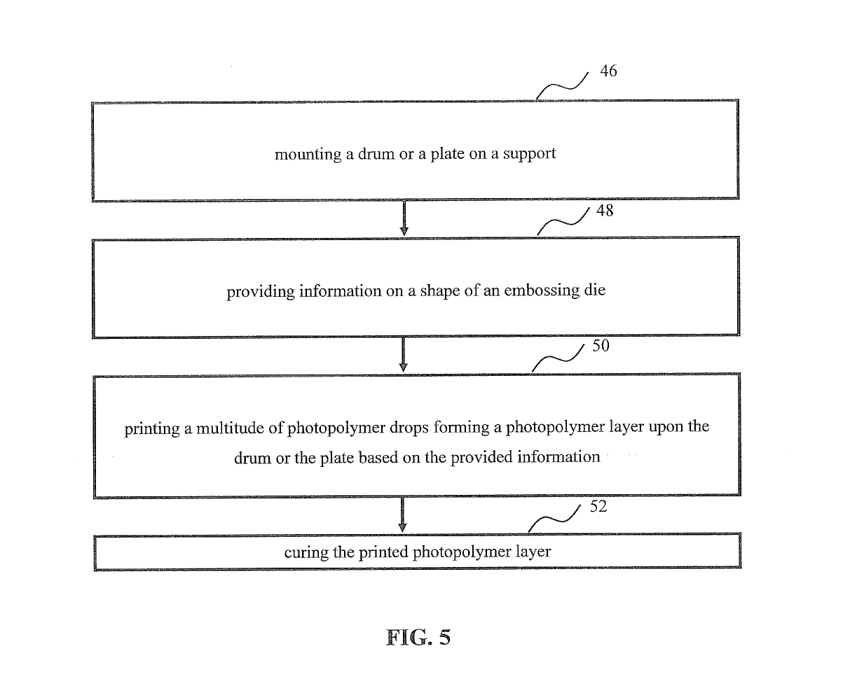

FIG. 5 is a flow chart of the embossing die 12, 12′, 14, 14′, 38, 44 manufacturing process which may be carried out in the apparatus 28, 28′ shown in FIGS. 2a and 2b, in the embossing drum manufacturing apparatus 34 shown in FIG. 3, or in the embossing plate manufacturing apparatus 40 shown in FIG. 4.

The manufacturing process comprises, at 46, mounting a drum 12, 14, 38 or a plate 12′, 14′, 44 on a support 36, 42. For example, the drum 12, 14, 38 or the plate 12′, 14′, 44 may be mounted on the support 36, 42 of the apparatus 28, 28′ shown in FIGS. 2a and 2b, the support 36 of the embossing drum manufacturing apparatus 34 shown in FIG. 3, or the support 42 of the embossing plate manufacturing apparatus 40 shown in FIG. 4.

Furthermore, as indicated at 48, information on a shape of the embossing die 12, 12′, 14, 14′, 38, 44 is provided. The information on the shape of the embossing die 12, 12′, 14, 14′, 38, 44 may comprise data related to the thickness of the embossing shape or data on a three-dimensional embossing shape. I.e., the information on the embossing shape indicates the thickness of the polymer layer of the raised portions and of the recessed portions. In this regard, it is to be noted that in case that the thickness of the polymer layer of the raised portions and of the recessed portions is not explicitly provided for an embossing shape, for example because a default thickness of the polymer layer of the raised portions and of the recessed portions is used or assumed, such implicit provision of data related to the thickness of the embossing shape or data on a three-dimensional embossing shape shall also be encompassed by the formulation of “providing information on a shape of the embossing die” as used throughout the description and claims.

After explicitly or implicitly providing information on a shape of the embossing die 12, 12′, 14, 14′, 38, 44, the manufacturing process continues at 50 with printing a multitude of photopolymer drops forming a photopolymer layer upon the drum 12, 14, 38 or the plate 12′, 14′, 44 based on the provided information. After printing the multitude of photopolymer drops framing the photopolymer layer, the process is finished at 52 by curing the printed photopolymer layer. As described above with reference to FIGS. 2a, 2b, 3, and 4, curing the printed photopolymer layer may comprise emitting UV light upon the printed photopolymer layer.

Furthermore, in order to allow for fast changes between different embossing shapes, the manufacturing process may further comprise, before the printing at 50, doctoring a polymer layer 18, 22 to be removed from the drum 12, 14, 38 or the plate 12′, 14′, 44. More specifically, a cured photopolymer layer previously printed upon the drum 12, 14, 38 or the plate 12′, 14′, 44 may be doctored from the drum 12, 14, 38 or the plate 12′, 14′, 44 in order to reuse the drum 12, 14, 38 or the plate 12′, 14′, 44 for embossing a substrate 26 with another embossing shape.

When the embossing die 12, 12′, 14, 14′, 38, 44 manufacturing process is carried out in the apparatus 28, 28′ shown in FIGS. 2a and 2b having two embossing dies 12, 12′, 14, 14′, a female embossing die 14, 14′ and a male embossing die 12, 12′ may be manufactured and the substrate 26 may be guided between the female embossing die and the male embossing die, so that the entire method is carried out on a single apparatus 28, 28′.

1. An embossing apparatus, comprising:
a first die having a first body on which an embossing shape is foliated by a first polymer layer adhering to a surface of the first body, a second die having a second body on which a background is formed by a second polymer layer adhering to a surface of the second body; and
a feeder to guide a substrate between the first die and the second die.

2. The embossing apparatus of claim 1, wherein at least a portion of the first polymer layer and the second polymer layer has a thickness of more than 25 microns or of more than 50 microns.

3. The embossing apparatus of claim 1, wherein the first die and the second die are rotary dies or flatbed dies.

4. The embossing apparatus of claim 1, wherein at least one of the first polymer layer and the second polymer layer is a photopolymer layer.

5. The embossing apparatus of claim 4, further comprising an ink jet print head to print a photopolymer layer directly on at least one of the surface of the first body and the surface of the second body.

6. The embossing apparatus of claim 5, further comprising an ultra violet (UV) light source, the UV light source to emit UV light upon at least one of the first die and the second die.

7. An embossing drum manufacturing apparatus, comprising:
a rotatable support to mount a drum thereon; and
an ink-jet print head to print a curable polymer layer directly upon the drum.

8. The embossing drum manufacturing apparatus of claim 7, wherein
the embossing drum manufacturing apparatus comprises an ultra violet (UV) light source; and
the curable polymer layer is a UV ink layer to be printed directly upon the drum.

9. An embossing plate manufacturing apparatus, comprising:
a support to mount a plate thereon; and
an ink jet print head to print a curable polymer layer upon the plate.

10. The embossing plate manufacturing apparatus of claim 9, wherein the embossing plate manufacturing apparatus comprises an ultra violet (UV) light source; and
the curable polymer layer is a UV ink layer to be printed directly upon the plate.

11. A method of manufacturing an embossing die comprising:
mounting a drum or a plate on a support;
providing information on a shape of the embossing die;
printing a multitude of photopolymer drops forming a photopolymer layer upon the drum or the plate based on the provided information; and
curing the printed photopolymer layer.

12. The method according to claim 11, wherein the information on the embossing shape comprises at least one of data related to the thickness of the embossing shape and data on a three-dimensional embossing shape.

13. The method according to claim 11, wherein curing the printed photopolymer layer comprises emitting ultra violet (UV) light upon the printed photopolymer layer.

14. The method according to claim 11, further comprising before the printing, doctoring a polymer layer to be removed from the drum or the plate.

15. A method of converting a substrate, the method comprising:
manufacturing a female embossing die and a male embossing die according to the method of claim 11, and
guiding a substrate between the female embossing die and the male embossing die, wherein the entire method is carried out on a single apparatus.
